(19) United States
(12) Patent Application Publication
(10) Pub. No.: US 2009/0164038 A1
(43) Pub. Date: Jun. 25, 2009

(54) METHOD FOR OPTIMIZING THE MACHINING PROCESS IN A MACHINE

(75) Inventors: Jochen Bretschneider, Esslingen (DE); Thomas Menzel, Bubenreuth (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, 80333 Munchen (DE)

(21) Appl. No.: 12/088,781

(22) PCT Filed: Sep. 22, 2006
(86) PCT No.: PCT/EP2006/066634

§ 371 Date: Aug. 5, 2008

(30) Foreign Application Priority Data
Sep. 30, 2005 (DE) 10 2005 047 466.7

(51) Int. Cl. G05B 19/4097; G05B 19/18

(52) U.S. Cl. 700/105; 700/182; 700/180

(57) ABSTRACT

The invention relates to a method for optimizing the machining process in a machine (1), wherein a control program (10) having a machining block (11a,11b,11c) controls the machining process, wherein an item of process information which arises during execution of the machining block (11a,11b,11c) is stored in a manner related to the machining block. Furthermore, the invention relates to a control device (2) for controlling a machine (1), wherein the control device (2) is designed in such a manner that it uses a control program (10) having a machining block (11a,11b,11c) to control the machining process, wherein an item of process information which arises during execution of the machining block (11a,11b,11c) is stored in a manner related to the machining block. The invention thus provides a simple possible way of optimizing the machining process in a machine.

The invention relates to a method for optimizing the machining process in a machine. The invention also relates to a control device for controlling a machine.

In machines such as machine tools, production machines and/or robots, it is customary practice to design the workpieces to be produced using a CAD (Computer Aided Design) system within what is known as the work preparation. The data about the designed geometry of the workpiece are then transmitted from the CAD system to what is known as a CAM (Computer Aided Manufacturing) system which, in the case of milling, for example, calculates and visually displays the cutting paths required for manufacturing the workpiece. Customarily, a further program, which is also referred to as postprocessor in specialist fields, is then used to produce the control program controlling the machining process on the machine from these milling data within the work preparation. In this case, the control program is also referred to as an NC subprogram in specialist fields. The finished control program is then transferred to a control device (e.g. numerical controller) for controlling the machine. The control program is used to control the machining process on the machine. In an installation for the control program and/or within the control program, this also involves stipulating the technological parameters required for the machining process, such as the spindle speed or the feed speed of the machine. If the user detects, during machining of the workpiece on the machine, that adverse tensioning or unusual noise is being produced, for example, then he reduces the maximum feed speed and/or the spindle speed, for example, until the symptoms have disappeared. Feedback of this experience into the work preparation is not provided or at best is provided orally by virtue of the user talking to the responsible specialist in the work preparation, however. The fact that the specialists in the work preparation do not receive any feedback or often receive only inadequate feedback from the user on the machine and there is therefore only inaccurate information available to the work preparation means that the machining process cannot be optimized at all or can be optimized only very coarsely. The result of this is that the machine's performance is not fully utilized and, by way of example, the machining process takes an unnecessarily long time and does not produce an optimum result, e.g. in terms of the achievable surface quality of the workpiece.

Laid-open specification DE 101 44 788 A1 discloses a method and an apparatus for safe high-performance recording of process data for numerically controlled industrial processing machines, where the process data are collected in a runtime-critical cyclic time domain and are stored in a data buffer store having FIFO characteristics at the cyclic clock rate, this data buffer store being read in a non-runtime-critical acyclic time domain and the data which are read being edited and stored as data records in a log memory.

Laid-open specification DE 101 33 612 A1 discloses a numerical controller for a machine tool, and also a method for numerical control and a method for monitoring a machine tool.

EP 0 813 130 A2 discloses a numerical controller for machine tools or robots, where a user of a numerical controller is presented with possible monitoring methods in a menu when inputting a subprogram, on the basis of data available in the system regarding individual tools used. When the menu has been accepted, a production process steered by the controller starts.

The invention is based on the object of optimizing the machining process in a machine.

This object is achieved by a method for optimizing the machining process in a machine, where a control program having a machining block controls the machining process, with a process information item which occurs during the execution of the machining block being stored in a file on a machining-block basis, the process information item being stored in the file within the control program.

In addition, this object is achieved by a control device for controlling a machine, where the control device is in a form such that it uses a control program having a machining block to control the machining process, with a process information item which arises during the execution of the machining block being stored in a file on a machining-block basis, the process information item being stored in the file within the control program.

It is found to be advantageous that the process information is stored in a file on a machining-block basis. If the process information is stored in a file on a machining-block basis then the process information can be interchanged particularly easily between various systems.

It is also found to be advantageous that the file is used to store the control program. If not only the process information but also the control program is stored in the same file then it is a simple matter to set up a reference between the process information and the associated machining block in the control program.

It is also found to be advantageous that the process information is stored in the file within the control program. This measure makes it a particularly simple matter to set up a reference between the process information and the associated machining block in the control program.

In this connection, it is found to be advantageous to the invention if the process information is stored in the file within the control program in the form of a comment. This allows the process information to be integrated into the control program elegantly.

It is also found to be advantageous to the invention if the process information stored on a machining-block basis is converted into a format which can be read by a visual display system. This allows the process information to be visually displayed by any standard visual display system, particularly by a CAM system.

It is also found to be advantageous to the invention if the process information is visually displayed by a visual display system. This makes it a simple matter for the user to record the process information graphically.

It is also found to be advantageous to the invention if the process information is visually displayed such that the process information is graphically associated with the location at which the process information arises during the machining. This allows the user to record the process information graphically together with the location at which the process information arises during the machining.

It is also found to be advantageous if the visual display system used is a CAM system. CAM systems are widely used visual display systems.

It is also found to be advantageous if the machine is in the form of a machine tool, production machine and/or in the form of a robot. Particularly in the technical field of machine tools, production machines and/or robots, it is frequently necessary to optimize machining processes. It goes without saying that the present invention can also be used in other technical fields, however.

Advantageous forms of the control device are obtained in similar fashion to advantageous forms of the method, and vice versa.

An exemplary embodiment of the invention is illustrated in the drawing and is shown in more detail below. In the drawing:

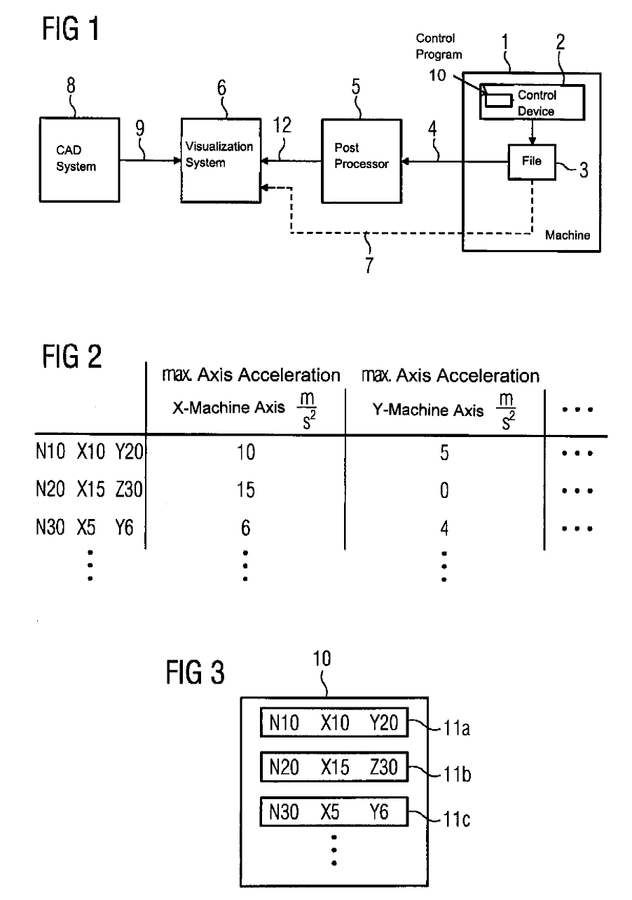

FIG. 1 shows a schematized illustration of the invention,

FIG. 2 shows process information which is stored in a file on a machining-block basis, and

FIG. 3 shows a control program.

FIG. 1 shows a machine 1 which has a control device 2 for controlling the machine 1. The machining process, e.g. milling of a workpiece, is performed using a control program 10 which controls the machining process.

A control program is usually made up of a multiplicity of machining blocks.

A typical extract from a control program is shown in FIG. 3. In this case, the control program 10 has a plurality of machining blocks, only the three machining blocks 11a, 11b and 11c being shown for reasons of clarity. Normally, each machining block has a number identifying it, for example the machining block 11a has the number N10. In addition, each machining block normally contains instructions, e.g. how the machine's machine axles need to be moved. The instruction X10 means that the machine's X machine axle needs to be moved to the position 10, for example, and the instruction Y20 means that the Y machine axle needs to be moved to the position 20.

In line with the invention, process information arising during the execution of the machining block is stored on a machining-block basis. In this case, the process information is measured by means of sensors and is edited in the control device 2 as appropriate, or else is produced directly in the form of process variables within the control device 2.

Typical process information is, by way of example:
the minimum, average and maximum feed speed which arises during execution of the machining block,
the minimum, average and maximum speeds of the machine axles which arise during the execution of the machining block,
the minimum, average and maximum axial accelerations for the machine axles which arise during the execution of the machining block,
the minimum, average and maximum current drawn (including the force or moment intake) which arise during the execution of the machining block,
the maximum speed of change (time derivation) in the current drawn by the motor, the respective machine axle, which arises during the execution of the machining block,
the average spindle speed (setpoint and actual value) which arises during the execution of the machining block,
the minimum, average and maximum moment of the spindle which arises during the execution of the machining block,
the maximum speed of change (time derivation) in the spindle moment which arises during the execution of the machining block,
the machining time for the machining block,
geometrical variables, particularly when characterized by process variable and/or machine dynamic variables (e.g. contouring errors and actual position).

In this case, the invention involves the process information being stored on a machining-block basis, i.e. the process information is stored such that the process information can be associated with the respective associated machining block during whose execution the process information has arisen. If appropriate, only a single process information item can also be stored on a machining-block basis, however.

In this context, the process information is preferably stored within a file 3 (see FIG. 1) on a machining-block basis. It is then particularly advantageous if the file is additionally also used to store the control program.

FIG. 2 shows an exemplary embodiment of such a file in which the process information is stored in the form of a table on a machining-block basis. In this case, the table has a multiplicity of columns, only three columns being shown in FIG. 2 for the sake of clarity and these being separated by lines indicated in dashes. The first column contains the control program, which is made up of a plurality of machining blocks. FIG. 2 shows only three machining blocks for the sake of clarity. For each machining block, the process information associated with the respective machining block is then written in the other columns. In the exemplary embodiment, during the execution of the first command set (N10 X10 Y20), for example, a maximum axial acceleration for the X machine axle of 10 m/s² and a maximum axial acceleration for the Y machine axle of 5 m/s² have been ascertained and written into the appropriate column in FIG. 2. According to the number of process information items which are intended to be stored on a machining-block basis, the file has a greater or lesser number of columns. The process information which is produced during the execution of the machining block is stored in such a way for the respective associated machining block on a machining-block basis.

Alternatively, it is also possible, by way of example, for the process information to be stored simply in the form of a comment within the control program, for example, and for the control program to be stored in a file, for example, however. The process information is in this way part of the control program.

The file 3 produced in this way is then transferred to a conversion means 5 (see FIG. 1), which is indicated by an arrow 4. The conversion means 5, which may be in the form of a conversely operating post processor 5, for example, converts the process information stored on a machining basis into a format which can be read by a visual display system 6. The format chosen in this context may be what is known as a CL (Cutter Location Data) format, for example, which can be read by any commercially available CAM system.

Next, the converted file is forwarded to the visual display system 6, which is indicated by an arrow 12. The visual display system 6, which may be in the form of CAM system, for example, is used to visually display the process information. If the visual display system 6 is able to read the format of the file 3 directly then it is not necessary to convert the file 3 and the file 3 can be supplied directly to the visual display system 6, which is illustrated by an arrow 7 indicated in dashes in FIG. 1.

In this context, it is particularly advantageous if the process information is visually displayed on the visual display system 6 such that the process information can be graphically associated with the location (e.g. tool position) at which the process information arises, during the machining. The appropriate process information is then revealed on the screen to the person skilled in the art in the work preparation, for example by virtue of his clicking on the appropriate location on the cutting path and/or on the workpiece. Visual display may then possibly require the visual display system 6 to be additionally provided with data, e.g. about the workpiece geometry, by a CAD system, which is indicated by an arrow 9.

Using the machining-block-based process information, a person skilled in the art in the work preparation can establish whether the user of the machine has altered technological parameters such as feed speed, override speed or spindle speed for the individual machining steps, for example. In addition, the person skilled in the art gets an idea of what accelerations and moments have arisen during a machining operation or what waiting times have been necessary for tool changes, spindle startup or modification of the spindle speed, for example. Using this information, the person skilled in the art can then optimize the machining process, e.g. by modifying the starting strategies and/or the machining technologies in a specific fashion, and can create a control program optimized in this way.

In addition to optimization of the machining process, the process information can also be used for classifying, certifying and/or documenting the machining process. In this context, the relevant process information is stored and archived for each workpiece produced.

1.-8. (canceled)

9. A method for optimizing a machining process in a machine, comprising the steps of:
storing in a file a control program having a machining block;
controlling the machining process with the control program;
updating the file with process information obtained during execution of the machining block, with the updated process information being associated with the machining block; and
generating based the updated process information an optimized control program for machining a workpiece.

10. The method of claim 9, wherein the process information is stored in the file within the control program in form of a comment.

11. The method of claim 9, wherein the process information stored on a machining-block basis is converted into a format which is readable by a visual display system.

12. The method of claim 9, further comprising the step of visually displaying the process information with a visual display system.

13. The method of claim 12, wherein the displaying step includes the step of graphically associating the process information with a location at which the process information is encountered during machining.

14. The method of claim 11, wherein the visual display system is a CAM system.

15. The method of claim 12, wherein the visual display system is a CAM system.

16. The method of claim 9, wherein the machine is a member selected from the group consisting of machine tool, production machine, and robot.

17. A control device for controlling a machine, comprising:
a control program stored on the control device and executing a machining block to control a machining process;
a database for storing the control program as a file, said database storing in addition as part of the file updated process information obtained during execution of the machining block, with the updated process information stored in the file being associated with the machining block; and
a visualization system for visualizing the updated process information for optimizing the machining process.

18. The control device of claim 17, wherein the visualization system comprises a visual display system for visually displaying the process information.

19. The control device of claim 18, further comprising a post-processor configured to read the process information from the database and converting the read process information into the format for visualization by the visualization system.

20. The control device of claim 18, wherein the visualization system is a CAM system.

21. The control device of claim 17, wherein the machine is a member selected from the group consisting of machine tool, production machine, and robot.
